(19) United States
(12) Patent Application Publication
(10) Pub. No.: US 2006/0018422 A1
(43) Pub. Date: Jan. 26, 2006

(54) Nuclear fuel assembly end cap arrangement

(76) Inventor: John A. Mayer, Rutland, MA (US)

Correspondence Address: KENYON & KENYON, ONE BROADWAY, NEW YORK, NY, 10004, US

(21) Appl. No.: 10/896,242

(22) Filed: Jul. 20, 2004

(51) Int. Cl. G21C 3/00

(52) U.S. Cl. 376/409

(57) ABSTRACT

A method and arrangement to control fuel material debris originating from a fuel assembly for a dry storage system wherein the method includes providing a damaged boiling water reactor nuclear fuel assembly, providing a bottom end cap configured to fit on a bottom of a boiling water reactor nuclear fuel assembly, inserting the bottom end cap into the damaged boiling water reactor nuclear fuel assembly such that the bottom end cap prevents debris from inside the damaged nuclear fuel assembly from leaving the bottom of the fuel assembly, providing a top end cap configured to fit on a top of the boiling water reactor nuclear fuel assembly, and inserting the top end cap into the top of the damaged boiling water reactor nuclear fuel assembly such that the top end cap prevents debris from inside the damaged nuclear fuel assembly from leaving the top of the fuel assembly.

### FIELD OF THE INVENTION

The present invention will permit damaged spent nuclear fuel assemblies at Boiling Water Reactors (BWRs) to be loaded into dry storage casks without requiring that they first be encapsulated in a secondary container. The invention takes advantage of the fact that BWR fuel is already shrouded along its entire length and all that is needed to contain the potential loss of fuel material are small end caps at the top and bottom of each fuel assembly. This invention will save BWR operators time and money.

### BACKGROUND INFORMATION

Fuel material debris originating from within damaged boiling water reactor spent fuel assemblies is a consideration that must be addressed when loading such assemblies into a dry storage system.

After the service life of the nuclear fuel assembly has been exhausted, the fuel assembly must be cooled and stored for extended periods of time to remove the heat generated by radioactive decay of fission products occurring within the spent fuel rods. The removal of the residual heat is accomplished by placing the spent fuel assembly in pools of cooling water which are maintained at a constant temperature to remove heat transferred from the spent fuel assembly. The fuel assemblies are often kept in this state for many years until the heat load in the spent fuel assembly is brought to a reduced level at which point the spent fuel assembly can be stored in a “dry” condition.

The spent fuel assembly with reduced heat load is placed in a cask which has an inert gaseous atmosphere to limit corrosion of a stored fuel assembly. If a fuel assembly has experienced cladding damage and there is the potential for loose fuel material, the fuel assembly is required to be placed within a secondary confinement device to limit the mobility of the fuel material within the dry storage system.

Boiling water and pressurized water reactor fuel assemblies that have been used in the nuclear reactor and that have their usable nuclear material enrichment exhausted can be stored in a dry condition if several key conditions are established. First, if the nuclear fuel assembly has a decay heat rate below an established threshold point, the fuel assembly may be cooled through air flowing around a dry cask storage arrangement, saving storage space and expense from fuel pool storage. Second, the fuel assembly must be intact such that loose fuel material within the nuclear fuel assembly is secured to ensure that movement of the material will not degrade the overall integrity of the storage system. To allow dry storage, fuel assemblies with known or suspect cladding damage are placed within the secondary confinement devices. This increases the cost of dry storage.

There is a need to provide a device that will restrict the movement of loose fuel material within the dry storage system without significantly increasing the cost and/or reconfiguring the dry storage system to accommodate larger containerized fuel assemblies.

There is a still further need to provide a device which will allow drainage of a spent boiling water reactor fuel assembly which has loose pieces/parts when the spent boiling water reactor fuel assembly is placed within a dry storage system.

There is also a further need to provide a device which will restrict loose fuel material within a boiling water reactor nuclear fuel assembly that will not impact the seismic response of the fuel assembly wherein the device installed is light and economical to manufacture.

### SUMMARY

It is therefore an objective of the present invention to provide a device that will restrict the movement of loose fuel material originating within a boiling water reactor fuel assembly.

It is also an objective of the present invention to provide a method to install a device into existing boiling water reactor fuel assemblies to restrict the movement of the loose fuel material within boiling water reactor fuel assemblies.

It is a still further objective of the present invention to provide a device that will allow a spent boiling water reactor fuel assembly to be stored within existing dry storage systems even though the assembly may have loose fuel material within the assembly.

It is a still further objective of the present invention to provide a device that will allow a spent boiling water reactor fuel assembly which has loose fuel material to be drained when the fuel assembly is placed in a dry storage system.

It is a still further objective of the present invention to provide a device which will restrict loose fuel material within a boiling water reactor nuclear fuel assembly that will not impact the seismic response of the fuel assembly and which is light and economical to manufacture.

The objectives of the present invention are achieved as illustrated and described. The present invention provides a method to control fuel material debris originating from a fuel assembly within a dry storage system. The method recites the steps of providing a damaged boiling water reactor nuclear fuel assembly, providing a bottom end cap configured to fit on a bottom of a boiling water reactor nuclear fuel assembly, inserting the bottom end cap into the damaged boiling water reactor nuclear fuel assembly such that the bottom end cap prevents debris from inside the damaged nuclear fuel assembly,from leaving the bottom of the fuel assembly, providing a top end cap configured to fit in a top of the boiling water reactor nuclear fuel assembly, and inserting the top end cap into the top of the damaged boiling water reactor nuclear fuel assembly such that the top end cap prevents debris from inside the damaged nuclear fuel assembly from leaving the top of the fuel assembly, and draining the damaged nuclear fuel assembly of water contained in the nuclear fuel channel through mesh screens in the end caps.

The present invention also provides an end cap arrangement for a BWR nuclear fuel assembly. The end cap arrangement is configured to fit in a top end and a bottom end of a BWR nuclear fuel assembly, enclosing the fuel assembly and confining loose fuel material originating from within the nuclear fuel assembly, wherein the arrangement encloses areas defined by a fuel channel of the BWR fuel assembly.

### BRIEF DESCRIPTION OF THE DRAWINGS

FIG. 1 is a plan elevation of an installed boiling water reactor nuclear fuel assembly top end cap arrangement.

FIG. 2 is a plan elevation of an installed boiling water reactor nuclear fuel assembly bottom end cap arrangement.

FIG. 3 is a side view of the boiling water reactor nuclear fuel assembly top end cap arrangement illustrated in FIG. 1.

FIG. 4 is a side view of a boiling water reactor nuclear fuel assembly bottom end cap arrangement of FIG. 3.

### DETAILED DESCRIPTION

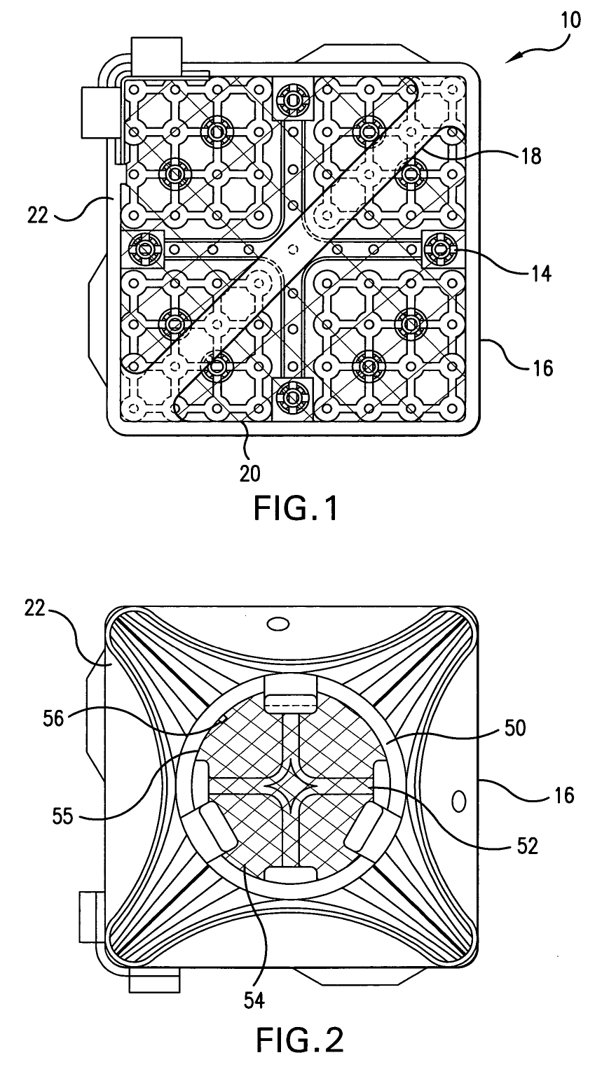

Referring to FIG. 1, a top end cap 10 of a boiling water reactor end cap arrangement is illustrated. The top end cap 10 is comprised of a member 12 that retains debris originating from within a fuel assembly (i.e. loose pieces/parts). The top end cap member 12 may be made of a mesh, or a solid piece with holes. The material for the top end cap member 12 may be a non-corrosive material or a corrosion-resistant material. Non-limiting exemplary materials may be alloys of stainless steel or Inconel. The top end cap 10 may be configured such that loose pieces/parts within the fuel assembly are contained within the fuel assembly. The diameters of objects being retained may be, for example, 0.01 cm. Other configurations are possible, where greater or lesser objects may be retained within the fuel assembly. The top end cap 10 may be configured to fit within the fuel channel 16 of the fuel assembly 22, thereby maintaining the overall outer profile of the fuel assembly 22. The top end cap 10 may also be configured of lightweight materials, such that the overall seismic response of the fuel assembly 22 is not appreciably changed by installation of the top end cap 10 inside the fuel assembly 22. The top end cap 10 may also be constructed such that the end cap 10 is installed underneath the bail 18 of the fuel assembly 22 in a single piece. The top end cap 10 may also be configured in multiple pieces and fit into position in the fuel assembly 22. The top end cap 10 may be secured in position through spring force, or through retainers 20 positioned around the exterior periphery section of the top end cap 10. The retainers 20 may be slot and tab devices or spring clips which allow non-permanent attachment of the retainer 20 to the fuel assembly 22.

Referring to FIG. 2, a bottom end cap 54 with a bottom member 55 for retaining loose pieces/parts inside a boiling water reactor nuclear fuel assembly 22 is illustrated. The bottom end cap 54 may be installed in a nozzle 50 of a fuel assembly 22. The bottom end cap 54 may be made of a mesh, or may be a solid piece, or a solid piece with holes. The material for the bottom end cap member may be a non-corrosive material or a corrosion resistant material. Non-limiting exemplary materials may be alloys of stainless steel or Inconel. Although illustrated as being installed over an optional cross flow restrictor, other configurations are possible. The bottom end cap 54 may also be configured of lightweight materials, such that the overall seismic response of the fuel assembly 22 is not appreciably changed by installation of the bottom end cap 54 inside the fuel assembly 22. The bottom end cap 54 may be configured with retainers 56 such that the bottom end cap 54 does not become dislodged. The bottom end cap 54 may also be configured such that spring force of the bottom end cap 54 retains the cap 54 in place during operation, thereby minimizing structural connections to the fuel assembly.

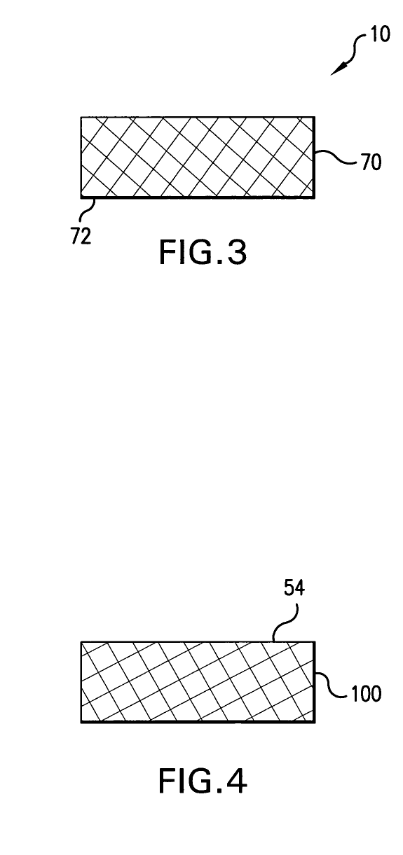

Referring to FIG. 3, a side of the boiling water reactor nuclear fuel assembly top end cap 10 arrangement is illustrated. The top end cap 10 may have a depth 70 chosen such that the top end cap 10 snuggly fits to an upper tie plate of the fuel assembly 22. The depth 70 may be chosen such that it is minimized or maximized to provide a larger or smaller overall structural profile of the top end cap 10. The overall width 72 of the top end cap 10 is chosen such that the entire top end cap 10 fits within the fuel channel 16 of the fuel assembly 22. The overall shape of the top end cap can be varied to the internal shape of the fuel assembly 22, such as square as illustrated.

Referring to FIG. 4, a side of a boiling water reactor nuclear fuel assembly bottom end cap arrangement 54 is illustrated. The side length 100 of the boiling water reactor nuclear fuel assembly bottom end cap 54 may be chosen such that the overall depth of the end cap 54 is minimized or maximized. The bottom end cap 54 overall shape may be varied to the internal shape of the bottom nozzle of the fuel assembly 22. As illustrated, the bottom end cap 54 may be round, however other configurations are possible and the exemplary embodiment should not be considered limiting.

The nuclear fuel assembly end cap arrangement provides plant operators many advantages during use of the end cap arrangement. The nuclear fuel assembly end cap arrangement is also configured such that the arrangement may be placed in existing fuel assemblies thereby not restricting normal fuel handling operations.

The present invention allows for a significant cost reduction in storing spent fuel assemblies which are degraded, wherein a limited capital cost arrangement is required for confining the loose fuel material in the fuel assembly. Encapsulation techniques which require the entire fuel assembly to be inserted into a confining device are eliminated by using the method and arrangement provided above. The nuclear fuel assembly end cap arrangement also allows for potential encapsulation of materials which have not yet degraded to such a point that loose debris has been created. For example, spent fuel assemblies which have a material degradation on a fuel rod cladding (such as fretting of the fuel rod) may be determined to be susceptible to creation of loose fuel material. To alleviate future concerns regarding cladding damage which may be developed over time, the end cap arrangements may be installed in the fuel assembly.

The present invention also provides an arrangement which will allow the seismic qualification of the spent nuclear fuel assembly to remain relatively unchanged after insertion of the end cap devices into the fuel assembly. This allows the spent fuel assembly with end caps installed to be cooled in existing spent fuel pool arrangements, decreasing the need for special pools or cooling arrangements for damaged boiling water reactor fuel assemblies.

The present invention also provides an arrangement wherein the spent fuel assembly may be drained of cooling fluid after removal of the spent fuel assembly from a cooling pool. The allowance of continued flow to and from the spent fuel assembly during cooling provides for optimum cooling of internal spent fuel assembly components over time and a safer overall structure.

The present invention also provides for the advantage of being adaptable to differing size pieces/parts within the spent nuclear fuel assembly, wherein the sizing of the mesh in the end cap arrangement may be varied to retain larger or smaller loose pieces/parts at the discretion of the installer.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

1. A method to control fuel material debris from leaving a fuel assembly system comprising:
providing a damaged boiling water reactor nuclear fuel assembly;
providing a bottom end cap configured to fit in a bottom of the damaged boiling water reactor nuclear fuel assembly;
inserting the bottom end cap into the damaged boiling water reactor nuclear fuel assembly such that the bottom end cap prevents debris from inside the damaged nuclear fuel assembly from leaving the bottom of the damaged fuel assembly;
providing a top end cap configured to fit in a top of the damaged boiling water reactor nuclear fuel assembly and underneath a bail of the boiling water reactor fuel assembly through the use of one of slot and tab devices and spring clips; and
inserting the top end cap into the top of the damaged boiling water reactor nuclear fuel assembly such that the top end cap prevents debris from inside the damaged nuclear fuel assembly from leaving the top of the fuel assembly.

2. The method to control fuel debris from leaving a fuel assembly in a dry storage system according to claim 1, wherein the bottom end cap secures to a bottom end of a fuel channel of the damaged boiling water reactor nuclear fuel assembly.

3. The method to control fuel debris from leaving a fuel assembly according to claim 1, wherein the top end cap secures to a top end of a fuel channel of the damaged boiling water reactor nuclear fuel assembly.

4. (canceled)

5. (canceled)

6. (canceled)

7. (canceled)

8. (canceled)
